(19) United States
(12) Patent Application Publication
(10) Pub. No.: US 2023/0388748 A1
(43) Pub. Date: Nov. 30, 2023

(54) METHOD AND APPARATUS FOR MONITORING LOCATION AND PROBLEMATIC EVENT OF USER EQUIPMENT

(71) Applicant: Samsung Electronics Co., Ltd., Gyeonggi-do (KR)

(72) Inventors: Narendranath Durga TANGUDU, Bangalore (IN); Sapan Pramodkumar SHAH, Bangalore (AD); Basavaraj Jayawant PATTAN, Bangalore (IN); Nishant GUPTA, Sitapur (IN)

(21) Appl. No.: 18/029,749

(22) PCT Filed: Oct. 6, 2021
(86) PCT No.: PCT/KR2021/013718

§ 371 Date: Mar. 31, 2023

(30) Foreign Application Priority Data
Oct. 6, 2020 (IN) 202041043507
Sep. 17, 2021 (IN) 202041043507

(51) Int. Cl. H04W 4/029; H04W 4/50; H04W 68/00

(52) U.S. Cl. CPC H04W 4/029; H04W 4/50; H04W 68/00; H04W 88/18

(57) ABSTRACT

Accordingly, embodiments herein disclose a method for monitoring deviation in location information of a VAL User Equipment (VAL-UE) in a wireless network. The method includes receiving, by a Location Management Service (LMS) of a Service Enabler Architecture Layer (SEAL) server, a monitor location subscription request from a VAL server. Further, the method includes determining, by the LMS of the SEAL server, the location information of the VAL-UE. Further, the method includes sending, by the LMS, a monitor location subscription response to the VAL server, where the monitor location subscription response indicates that the LMS of the SEAL server accepts the monitor location subscription request to monitor the deviation in the location information of the VAL-UE. Further, the method includes monitoring problematic event(s) of the VAL-UE in the wireless network.

### TECHNICAL FIELD

The present application relates generally to wireless communication systems, more specifically, the present disclosure relates to monitoring location and problematic event(s) of VAL-UE.

### BACKGROUND ART

To meet the demand for wireless data traffic having increased since deployment of 4th generation (4G) communication systems, efforts have been made to develop an improved 5th generation (5G) or pre-5G communication system. The 5G or pre-5G communication system is also called a ‘beyond 4G network’ or a ‘post long term evolution (LTE) system’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beamforming, and large scale antenna techniques are discussed with respect to 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

In the 5G system, hybrid frequency shift keying (FSK) and Feher's quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, MTC, and M2M communication may be implemented by beamforming, MIMO, and array antennas. Application of a cloud RAN as the above-described big data processing technology may also be considered to be as an example of convergence between the 5G technology and the IoT technology.

As described above, various services can be provided according to the development of a wireless communication system, and thus a method for easily providing such services is required.

### DISCLOSURE OF INVENTION

### Solution to Problem

In an exemplary embodiment, a method performed by a service enabler architecture layer (SEAL) server for monitoring location information of at least one vertical application layer (VAL)-user equipment (UE) in a wireless network is provided. The method includes receiving, by a location management service (LMS) of the SEAL server, a monitor location subscription request from a VAL server, determining, by the LMS, the location information of the at least one VAL-UE, and sending, by the LMS, a monitor location subscription response to the VAL server, wherein the monitor location subscription response indicates that the LMS accepts the monitor location subscription request to monitor the location information of the at least one VAL-UE.

### BRIEF DESCRIPTION OF DRAWINGS

This disclosure is illustrated in the accompanying drawings, throughout which like reference letters indicate corresponding parts in the various figures. The embodiments herein will be better understood from the following description with reference to the drawings, in which:

FIG. 1 illustrates a block diagram of a Service Enabler Architecture Layer (SEAL) server for monitoring deviation in location information and problematic event(s) of a VAL User Equipment (VAL-UE), according to an embodiment as disclosed herein;

FIG. 2 is an example sequence diagram illustrating various operations for monitoring the deviation in the location information of the VAL-UE, according to an embodiment as disclosed herein;

FIGS. 3-4 are example sequence diagrams illustrating various operations for monitoring the problematic event(s) of a VAL User Equipment (VAL-UE), according to an embodiment as disclosed herein;

FIG. 5 illustrates a user equipment (UE) according to embodiments of the present disclosure;

FIG. 6 illustrates an entity according to embodiments of the present disclosure; and

FIG. 7 illustrates a server according to embodiments of the present disclosure.

### BEST MODE FOR CARRYING OUT THE INVENTION

Accordingly, embodiments herein disclose a method for monitoring location information of a Vertical Application Layer (VAL) User Equipment (VAL-UE) in a wireless network. The method includes receiving, by a Location Management Service (LMS) of a Service Enabler Architecture Layer (SEAL) server, a monitor location subscription request from a VAL server. Further, the method includes determining, by the LMS, the location information of the VAL-UE. Further, the method includes sending, by the LMS, a monitor location subscription response to the VAL server, wherein the monitor location subscription response indicates that the LMS accepts the monitor location subscription request to monitor the location information of the VAL-UE.

In an embodiment, the location information comprises a deviation in the location information.

In an embodiment, the monitor location subscription request includes an identifier of the VAL-UE (VAL-UE-ID), an area of interest information of the VAL-UE, a notify interval and a target notification of Uniform Resource Identifier (URI).

In an embodiment, where determining, by the LMS, the location information of the VAL-UE includes processing, by the LMS, the area of interest information received in the monitor location subscription request. Further, the method includes subscribing, by the LMS, to the location information of the VAL-UE from a 3rd Generation Partnership Project (3GPP) core network as specified in 3GPP TS 23.502 by mapping a plurality of parameters, where the plurality of parameters includes a location type, a monitoring type, and an accuracy level. Further, the method includes periodically receiving, by the LMS, the location information of the VAL-UE from the 3GPP core network based on the subscription.

In an embodiment, where determining, by the LMS, the location information of the VAL-UE includes subscribing, by the LMS, to the location information of the VAL-UE from a SEAL location information procedures as specified in 3GPP TS 23.434. Further, the method includes periodically receiving, by the LMS, the location information of the VAL-UE from the SEAL location information procedures based on the subscription.

In an embodiment, where monitoring the location information of the VAL-UE includes determining, by the LMS, whether the received location information of the VAL-UE from the 3GPP core network matches with the received location information of the VAL-UE from the SEAL location information procedures. Further, the method includes sending a notify mismatch location message to the VAL server in response to determining that the received location information of the VAL-UE from the 3GPP core network does not match with the received location information of the VAL-UE from the SEAL location information procedures. Further, the method includes sending one of a notify presence message and a notify absence message to the VAL server in response to determining that the received location information of the VAL-UE from the 3GPP core network matches with the received location information of the VAL-UE from the SEAL location information procedures.

In an embodiment, where sending one of the notify presence message and the notify absence message to the VAL server includes determining, by the LMS, whether a current location of the VAL-UE is within the area of interest. Further, the method includes sending the notify presence message to the VAL server in response to determining that the current location of the VAL-UE is within the area of interest. Further, the method includes sending the notify absence message to the VAL server in response to determining that the current location of the VAL-UE is not within the area of interest.

In an embodiment, the notify mismatch location message, the notify presence message, and the notify absence message includes the VAL-UE-ID, the location information of the VAL-UE from the 3GPP core network, and the location information of the VAL-UE from the SEAL location information procedures.

Accordingly, embodiments herein disclose a method for monitoring a problematic event(s) of a VAL User Equipment (VAL-UE) in a wireless network. The method includes receiving, by a Network Resource Management (NRM) service of the SEAL server, a monitor event subscription request from a VAL server to monitor the problematic event(s) of the VAL-UE, where the monitor event subscription request includes an identifier of the VAL-UE (VAL-UE-ID) and the problematic event(s) includes a loss of connectivity, a communication failure, abnormal behavior and like so. Further, the method includes determining, by the NRM, whether the VAL server is authorized to initiate the monitoring events subscription request. Further, the method includes sending, by the NRM, a monitoring events subscription response message to the VAL server in response to determining that the VAL server is authorized to initiate the monitoring events subscription request. Further, the method includes subscribing, by the NRM, to monitor the problematic event(s) of the VAL-UE from a 3rd Generation Partnership Project (3GPP) core network as specified in 3GPP TS 23.502 and 3GPP TS 23.288.

In an embodiment, the method further includes sending, by the NRM, a notify monitoring event message to the VAL server, where the NRM aggregates notifications when multiple events are to be notified from the 3GPP core network and sends the multiple events to the VAL server.

Accordingly, embodiments herein disclose the SEAL server for monitoring the location information of the VAL-UE in the wireless network. The SEAL server includes the LMS coupled with a processor and a memory. The LMS is configured to receive the monitor location subscription request from the VAL server. Further, the LMS is configured to determine the location information of the VAL-UE. Further, the LMS is configured to send the monitor location subscription response to the VAL server, where the monitor location subscription response indicates that the LMS accepts the monitor location subscription request to monitor the location information of the VAL-UE.

Accordingly, embodiments herein disclose the SEAL server for monitoring the problematic event(s) of the VAL-UE in the wireless network. The SEAL server includes the NRM coupled with the processor and the memory. The NRM is configured to receive the monitor event subscription request from the VAL server to monitor the problematic event(s) of the VAL-UE. Further, the NRM is configured to determine whether the VAL server is authorized to initiate the monitoring events subscription request. Further, the NRM is configured to send the monitoring events subscription response message to the VAL server in response to determining that the VAL server is authorized to initiate the monitoring events subscription request. Further, the NRM is configured to subscribe to monitor the problematic event(s) of the VAL-UE from the 3GPP core network as specified in 3GPP TS 23.502 and 3GPP TS 23.288.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings.

In general, 3rd Generation Partnership Project (3GPP) group is actively researching application architecture aspects to support Unmanned Aerial Systems (UAS) in 5th Generation (5G) networks, as well as related architectural solutions. The research is documented in 3GPP Technical Report (TR) 23.755. The research involves defining architectural requirements required to allow effective usage and deployment of an application layer support for the UAS in the 5G networks.

According to 3GPP Technical Specification (TS) 22.125, the 3GPP system supports detection, identification, and reporting of a problematic Unmanned Aerial Vehicle (UAV(s)) (e.g. a VAL User Equipment (VAL-UE)) and a UAV controller to a UAS Traffic Management (UTM). To detect a problematic UAV(s), many dynamic events (e.g. loss of connectivity, communication failure, etc.) of the UAV(s) need to be taken into consideration to conclude that the UAV(s) is problematic. Achieving this (to detect a problematic UAV(s)) needs constant monitoring and processing of the dynamic events from the UAV(s). Currently, there is no standard way of detecting the problematic UAV(s) from a set of UAV(s) served by a UAS Service Supplier (USS) and/or the UTM. In some scenarios, such as a drone swarming, a platooning, etc., an authorized UAV/UAS may need to be aware of the problematic UAV(s) among the set of UAV(s).

According to requirements [R-5.1-012] and [R-5.1-013] of the 3GPP TS 22.125, one of the key functionality of the UTM is to track a location of the UAV(s). Furthermore, for “Automatic flight by the UTM” control mode, the UTM must be aware of the UAV(s) flight route and monitor whether the UAV(s) is within a pre-scheduled flight path or not. Currently, there is no standard way of detecting whether the UAV(s) is within a pre-scheduled flight path or not.

Besides the UAS, the 3GPP is also specifying enabling various other industry verticals (such as Factories for Future, Vehicle to Everything (V2X), etc.) communication over the 5G networks. The application layer support for these verticals also requires detection of vertical-specific problematic User Equipment (UE(s)). Hence, the above-stated problem(s) is also applicable for every vertical-specific application that wishes to detect the vertical-specific problematic UE(s). Thus, it is desired to provide a useful alternative for monitoring location deviation and problematic event(s) of the UAV(s) and/or the vertical-specific problematic UE(s).

Accordingly, embodiments herein disclose a method for monitoring deviation in location information of a VAL User Equipment (VAL-UE) in a wireless network. The method includes receiving, by a Location Management Service (LMS) of a Service Enabler Architecture Layer (SEAL) server, a monitor location subscription request from a VAL server. Further, the method includes determining, by the LMS, the location information of the VAL-UE. Further, the method includes sending, by the LMS, a monitor location subscription response to the VAL server, where the monitor location subscription response indicates that the LMS accepts the monitor location subscription request to monitor the deviation in the location information of the VAL-UE.

Accordingly, embodiments herein disclose a method for monitoring a problematic event(s) of a VAL User Equipment (VAL-UE) in a wireless network. The method includes receiving, by an NRM of the SEAL server, a monitor event subscription request from a VAL server to monitor the problematic event(s) of the VAL-UE, where the monitor event subscription request includes an identifier of the VAL-UE (VAL-UE-ID) and the problematic event(s) includes a loss of connectivity, a communication failure, abnormal behavior and like so. Further, the method includes determining, by the NRM, whether the VAL server is authorized to initiate the monitoring events subscription request. Further, the method includes sending, by the NRM, a monitoring events subscription response message to the VAL server in response to determining that the VAL server is authorized to initiate the monitoring events subscription request. Further, the method includes subscribing, by the NRM, to monitor the problematic event(s) of the VAL-UE from a 3rd Generation Partnership Project (3GPP) core network as specified in 3GPP TS 23.502 and 3GPP TS 23.288.

Accordingly, embodiments herein disclose the SEAL server for monitoring the location information of the VAL-UE in the wireless network. The SEAL server includes the LMS coupled with a processor and a memory. The LMS is configured to receive the monitor location subscription request from the VAL server. Further, the LMS is configured to determine the location information of the VAL-UE. Further, the LMS is configured to send the monitor location subscription response to the VAL server, where the monitor location subscription response indicates that the LMS accepts the monitor location subscription request to monitor the location information of the VAL-UE.

Accordingly, embodiments herein disclose the SEAL server for monitoring the problematic event(s) of the VAL-UE in the wireless network. The SEAL server includes the NRM coupled with the processor and the memory. The NRM is configured to receive the monitor event subscription request from the VAL server to monitor the problematic event(s) of the VAL-UE. Further, the NRM is configured to determine whether the VAL server is authorized to initiate the monitoring events subscription request. Further, the NRM is configured to send the monitoring events subscription response message to the VAL server in response to determining that the VAL server is authorized to initiate the monitoring events subscription request. Further, the NRM is configured to subscribe to monitor the problematic event(s) of the VAL-UE from the 3GPP core network as specified in 3GPP TS 23.502 and 3GPP TS 23.288.

Unlike existing methods and systems, the proposed method allows the LMS of the SEAL server to monitor deviation in location information of a VAL User Equipment (VAL-UE) (e.g. UAV(s)) in a given area of interest by subscribing to the location information of the VAL-UE from a 3rd Generation Partnership Project (3GPP) core network as specified in 3GPP TS 23.502 and a SEAL location information procedures as specified in 3GPP TS 23.434. The SEAL server's LMS then compares the subscribed location information and sends a message (e.g. notify mismatch location message, a notify presence message, a notify absence message, etc.) to a VAL server to take appropriate action(s) to ensure that the UAV(s) do not deviate from a pre-scheduled flight path.

Unlike existing methods and systems, the proposed method allows the NRM of the SEAL server to monitor a problematic event(s) of the VAL-UE by subscribing to monitor the problematic event(s) of the VAL-UE from the 3GPP core network as specified in 3GPP TS 23.502 and 3GPP TS 23.288. The SEAL server's NRM service then sends a message (e.g. notify monitoring event message) to the VAL server for it to take appropriate action(s) to resolve the detected problematic event(s) associated with the UAV(s).

The principal object of the embodiments herein is to monitor, by a Location Management Service (LMS) of a Service Enabler Architecture Layer (SEAL) server, deviation in location information of a VAL User Equipment (VAL-UE) (e.g. UAV(s)) in a given area of interest. The LMS of the SEAL server subscribes to the location information of the VAL-UE from a 3rd Generation Partnership Project (3GPP) core network as specified in 3GPP TS 23.502 and a SEAL location information procedures as specified in 3GPP TS 23.434 to monitor the deviation. The SEAL server's LMS then compares the subscribed location information and sends a message (e.g. notify mismatch location message, a notify presence message, a notify absence message, etc.) to a VAL server for it to take appropriate action(s) to ensure that the UAV(s) do not deviate from a pre-scheduled flight path.

Another object of the embodiments herein is to monitor a problematic event(s) of the VAL-UE by subscribing to monitor the problematic event(s) of the VAL-UE from the 3GPP core network as specified in 3GPP TS 23.502 and 3GPP TS 23.288. The SEAL server's NRM service then sends a message (e.g. notify monitoring event message) to the VAL server for it to take appropriate action(s) to resolve the detected problematic event(s) associated with the UAV(s).

Another object of the embodiments herein is to detect location deviation of the VALUE(s) (e.g. UAV(s)) and The SEAL server's LMS reports to the VAL server (e.g. Unmanned Aerial Systems (UAS)/UAS Traffic Management (UTM)), only when the VAL-UE(s) deviates from an area of interest. Based on a request from the VAL server, the SEAL server's LMS sends a periodic notification when the VAL-UE(s) is within the area of interest.

Another object of the embodiments herein is to provide a SEAL supporting location deviation monitoring and events monitoring services, which are consumed by UAS application layer entities (e.g. the USS/UTM) for detection of location deviation and monitoring of events related to the VAL-UE(s).

Another object of the embodiments herein is to provide an offload of all individual subscriptions from the USS/UTM to the SEAL server and the SEAL server collates reports to identify problematic the VAL-UE(s) (e.g. UAV(s)) and share the details with the VAL server (e.g. USS/UTM).

Another object of the embodiments herein is to specify new services such as location deviation monitoring and event monitoring, for SEAL location management and network resource management servers respectively. These services can be consumed by the UAS application layer entities and also by application layer entities belonging to other verticals.

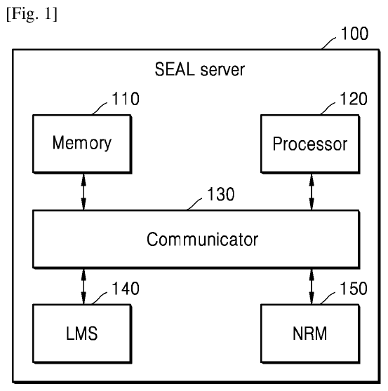

Referring now to the drawings and more particularly to FIGS. 1 through 7, where similar reference characters denote corresponding features consistently throughout the figures, there are shown preferred embodiments.

FIG. 1 illustrates a block diagram of a Service Enabler Architecture Layer (SEAL) server (100) for monitoring location information and problematic event(s) of a VAL User Equipment (VAL-UE) (400), according to an embodiment as disclosed herein.

In an embodiment, the SEAL server (100) includes a memory (110), a processor (120), a communicator (130), a Location Management Service (LMS) (140) (i.e. LMS entity), and a Network Resource Management (NRM) (150) (i.e. NRM entity).

The memory (110) stores an identifier of the VAL-UE (400) (VAL-UE-ID), an area of interest information of the VAL-UE (400), a notify interval and a target notification of Uniform Resource Identifier (URI), location information of the VAL-UE (400) from a 3rd Generation Partnership Project (3GPP) core network as specified in 3GPP TS 23.502, location information of the VAL-UE (400) from a SEAL location information procedures as specified in 3GPP TS 23.434, and problematic event(s) of the VAL-UE (400) from a 3rd Generation Partnership Project (3GPP) core network as specified in 3GPP TS 23.502 and 3GPP TS 23.288. Further, the memory (110) also stores instructions to be executed by the processor (120). The memory (110) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In some examples, the memory (110) can be configured to store larger amounts of information. In certain examples, a non-transitory storage medium may store data that can, over time, change (e.g., in Random Access Memory (RAM) or cache). The memory (110) can be an internal storage unit or it can be an external storage unit of the SEAL server (100), a cloud storage, or any other type of external storage.

The processor (120) communicates with the memory (110), the communicator (130), the LMS (140) and the NRM (150). The processor (120) is configured to execute instructions stored in the memory (110) and to perform various processes. The processor (120) may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (130) includes an electronic circuit specific to a standard that enables wired or wireless communication. The communicator (130) is configured for communicating internally between internal hardware components and with external devices via one or more networks.

In an embodiment, the LMS (140) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductors.

In an embodiment, the LMS (140) receives a monitor location subscription request from a VAL server (200). Further, the LMS (140) determines the location information of the VAL-UE (400). Further, the LMS (140) sends a monitor location subscription response to the VAL server (200), where the monitor location subscription response indicates that the LMS (140) accepts the monitor location subscription request to monitor the location information of the VAL-UE (400). The location information includes a deviation in the location information. The monitor location subscription request includes the VAL-UE-ID, the area of interest information of the VAL-UE (400), the notify interval and the target notification of URI.

Further, the LMS (140) processes the area of interest information received in the monitor location subscription request. Further, the LMS (140) subscribes to the location information of the VAL-UE (400) from the 3GPP core network as specified in 3GPP TS 23.502 by mapping a plurality of parameters, where the plurality of parameters comprises a location type, a monitoring type, and an accuracy level. Further, the LMS (140) periodically receives the location information of the VAL-UE (400) from the 3GPP core network based on the subscription.

Further, the LMS (140) subscribes to the location information of the VAL-UE (400) from a SEAL location information procedures as specified in 3GPP TS 23.434. Further, the LMS (140) periodically receives the location information of the VAL-UE (400) from the SEAL location information procedures based on the subscription.

Further, the LMS (140) determines whether the received location information of the VAL-UE (400) from the 3GPP core network matches with the received location information of the VAL-UE (400) from the SEAL location information procedures. Further, the LMS (140) sends a notify mismatch location message to the VAL server (200) in response to determining that the received location information of the VAL-UE (400) from the 3GPP core network does not match with the received location information of the VAL-UE (400) from the SEAL location information procedures. Further, the LMS (140) sends one of a notify presence message and a notify absence message to the VAL server (200) in response to determining that the received location information of the VAL-UE (400) from the 3GPP core network matches with the received location information of the VAL-UE (400) from the SEAL location information procedures.

Further, the LMS (140) determines whether a current location of the VAL-UE (400) is within the area of interest. Further, the LMS (140) sends the notify presence message to the VAL server (200) in response to determining that the current location of the VAL-UE (400) is within the area of interest. Further, the LMS (140) sends the notify absence message to the VAL server (200) in response to determining that the current location of the VAL-UE (400) is not within the area of interest.

The notify mismatch location message, the notify presence message, and the notify absence message includes the VAL-UE-ID, the location information of the VAL-UE (400) from the 3GPP core network, and the location information of the VAL-UE (400) from the SEAL location information procedures.

In an embodiment, the NRM (150) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductors.

In an embodiment, the NRM (150) receives a monitor event subscription request from the VAL server (200) to monitor the problematic event(s) of the VAL-UE (400). Further, the NRM (150) determines whether the VAL server (200) is authorized to initiate the monitoring events subscription request. Further, the NRM (150) sends a monitoring events subscription response message to the VAL server (200) in response to determining that the VAL server (200) is authorized to initiate the monitoring events subscription request. Further, the NRM (150) subscribes to monitor the problematic event(s) of the VAL-UE (400) from a 3rd Generation Partnership Project (3GPP) core network as specified in 3GPP TS 23.502 and 3GPP TS 23.288.

The monitor event subscription request comprises an identifier of the VAL-UE (400) (VAL-UE-ID) and the problematic event(s) comprises a loss of connectivity, a communication failure, and abnormal behaviour.

Further, the NRM (150) sends a notify monitoring event message to the VAL server (200), where the NRM (150) server aggregates notifications when multiple events are to be notified from the 3GPP core network and sends the multiple events to the VAL server (200).

Although the FIG. 1 shows various hardware components of the SEAL server (100) but it is to be understood that other embodiments are not limited thereon. In other embodiments, the SEAL server (100) may include less or more number of components. Further, the labels or names of the components are used only for illustrative purpose and does not limit the scope of the disclosure. One or more components can be combined together to perform same or substantially similar function to monitor the location information and the problematic event(s) of the VAL-UE (400) in the wireless network.

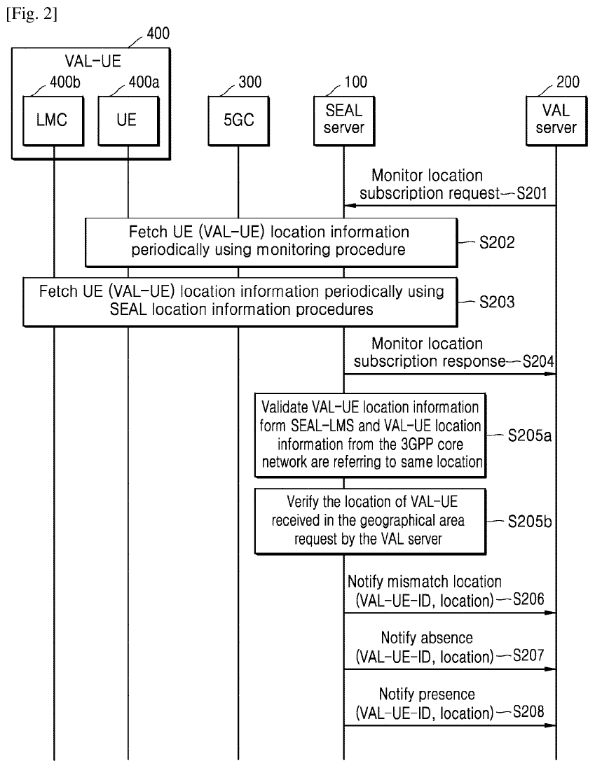

FIG. 2 is an example sequence diagram illustrating various operations for monitoring the deviation in the location information of the VAL-UE, according to an embodiment as disclosed herein.

At S201, the VAL server (200) sends the monitor location subscription request to the LMS (140). The monitor location subscription request includes the VAL-UE-ID, predetermined area of interest information, notification interval, deviation threshold, and notification URI where the VAL server (200) intends to receive notifications from the LMS (140) regarding the presence of the VAL-UE (400) in the given area (i.e. predetermined area of interest information).

The “area of interest” is the location information of the VAL-UE (400), which the VAL server (200) wishes to monitor the VAL UE's location adherence. This parameter can include the area of interest information and other relevant parameters like accuracy information of the location, location format and like so. The “Notify_Interval (notification interval)” represents a periodic interval in which the LMS (140) needs to notify the location information of the VAL-UE (400) to the VAL server (200). When the VAL-UE (400) moves away from the “area of interest”, then the LMS (140) ignores the “Notify_Interval” and sends the location notification to the VAL server (200) immediately. The deviation threshold represents the acceptable deviation from the pre-scheduled flight path. Value of 0 or absence of deviation threshold indicates zero tolerance of UAV's path deviation. Table 1 shows the monitor location subscription request information.

TABLE 1

| Information | | |
|---|---|---|
| element | Status | Description |
| Identity | M | Identifier of the VAL users or VAL-UE whose location |
| | | monitoring is requested to be monitored in a given location. |
| Area of | M | Geographic area location information where the VAL server |
| Interest | | wishes to monitor the VAL UE's location adherence. |
| Notify | M | Periodic time interval in which the LM server needs to notify |
| Interval | | the VAL UE's location information to the VAL server. |

At S202, the LMS (140) processes the area of interest information in the received the monitor location subscription request and then subscribes to UE location monitoring as specified in 3GPP TS 23.502 with appropriate parameters mapping. Based on the subscription, the LMS (140) receives the location information of the VAL-UE (400) periodically from the 3GPP core network (i.e. 5GC (300)).

At S203, the LMS (140) uses the location information procedures as specified in clause 9.3.7 and clause 9.3.10 of TS 23.434, to periodically obtain the location information of the VAL-UE (400). Based on geographic information from the VAL server (200), the LMS (140) may determine to additionally include positioning methods in the SEAL-LMS procedures to obtain the location information of the VAL-UE (400). The LMS (140) includes the positioning methods in an SS_LocationInfoEvent API invocation. Examples of the positioning methods, but are not limited to, non-3GPP positioning technologies such as Global Navigation Satellite System (GNSS), Network-based assisted GNSS and High-Accuracy GNSS, terrestrial beacon systems, dead-reckoning sensors (e.g. IMU, barometer), Wireless Local-Area Network (WLAN) based positioning, Bluetooth based positioning, etc.)

At S204, after successful subscription according to S202 and S203, the LMS (140) sends the monitor location subscription response to the VAL server (200). The monitor location subscription response indicates that that the LMS (140) accepts the monitor location subscription request of the VAL server (200). The LMS (140) then monitors the location information of the VAL-UE (400) to verify if the VAL-UE (400) is in the area of interest.

At S205a-S205b, the LMS (140) processes the location information of the VAL-UE (400) received from the SEAL-LMS procedures (seal location information procedures) and the 3GPP core network and validates the received information. If the received location information of the VAL-UE (400) is matching, then the LMS (140) determines if the current location of the VAL-UE (400) is within the area of interest received in step-1 (i.e. S201). For example, at S205a, the LMS (140) may validate VAL-UE location information from SEAL-LMS in S203 and VAL-UE location information from the 3GPP core network in S204, are referring to same location. At S205b, the LMS (140) may verify the location of VAL-UE received in geographical area request by the VAL server.

At S206, if the current location information of the VAL-UE (400) received from the SEAL-LMS procedures (seal location information procedures) and the 3GPP core network does not match, then the LMS (140) consider that the VAL-UE (400) as outside from its specified area of interest (i.e. the area of interest). The LMS (140) then notifies (“Notify Mismatch Location” message) the VAL server (200). The notify mismatch location message includes the VAL-UE-ID and the current location information received from the SEAL-LMS procedures (seal location information procedures) and the 3GPP core network.

At S207, if the current location information of the VAL-UE (400) received from the SEAL-LMS procedures (seal location information procedures) and the 3GPP core network matches and the current location information of the VAL-UE (400) is not in the area of interest received from VAL server (200) in the monitor location subscription request message (i.e. step-1 (i.e. S201)), then the LMS (140) considers that the VAL-UE (400) as outside from its specified area of interest. The LMS (140) then notifies (“Notify Absence” message) the VAL server (200) that the current location information of the VAL-UE (400) is outside of the area of interest. The notify absence message includes the VAL-UE-ID and the current location information received from the SEAL-LMS procedures (seal location information procedures) and the 3GPP core network

At S208, when the current location information of the VAL-UE (400) is within the area of interest, then the LMS (140) notifies (“Notify Presence” message) the VAL server (200) periodically, according to the “Notify_Interval” value in the monitor location subscription request message (i.e. step-1 (i.e. S201)). The notify presence message indicates that the VAL-UE (400) is within the area of interest and includes the VAL-UE-ID and the current location information received from the SEAL-LMS procedures (seal location information procedures) and the 3GPP core network. Table 2 shows information of the notifies location monitoring event message.

TABLE 2

| Information | | |
|---|---|---|
| element | Status | Description |
| Event | M | Information of the event to be reported. The event shall be one |
| | | of the following:”Notify_Mismatch_Location” - When the |
| | | location information of the VAL-UE, from the location |
| | | management client and the core network does not match. |
| | | “Notify_Absence” - When the VAL UE's current location is |
| | | deviating from the VAL server's area of interest information. |
| | | “Notify_Presence” - When the VAL UE's current location is |
| | | within the VAL server's area of interest information. |
| Identity | M | Identifier of the VAL UE whose location information is |
| | | reported. |
| Location | M | Current location of the VAL UE. |

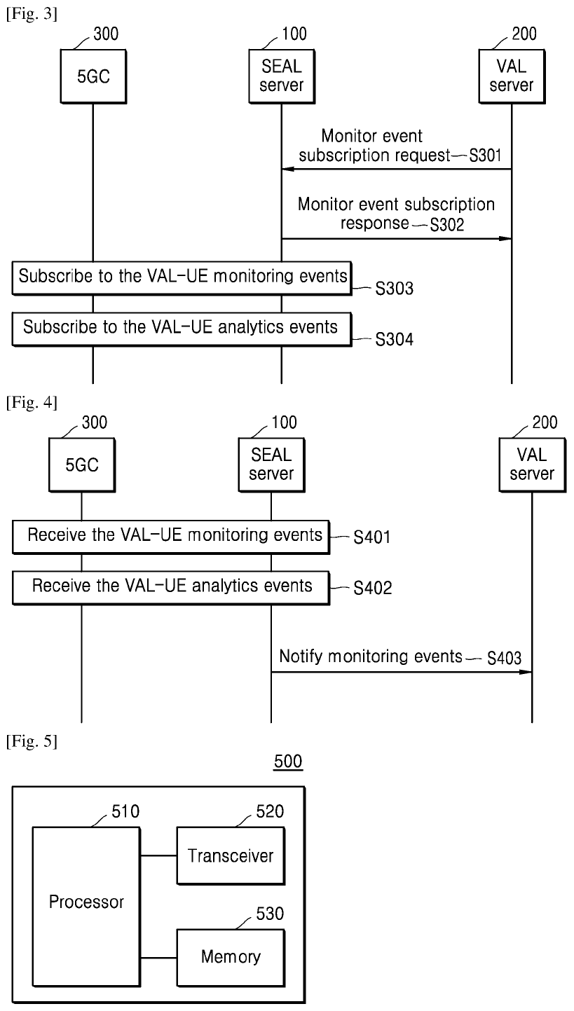

FIGS. 3-4 are example sequence diagrams illustrating various operations for monitoring the problematic event(s) of the VAL-UE (400), according to an embodiment as disclosed herein.

Referring to FIG. 3: At S301, the VAL server (200) sends the monitoring events subscription request to the NRM (150) of the SEAL server (100), requesting the NRM (150) of the SEAL server (100) to monitor the events related to the VAL-UE (400) as per subscription request. The monitoring events subscription request includes information related to the events that the VAL server (200) is interested in and the VALUE-ID.

At S302, the NRM (150) of the SEAL server (100) determines whether the VAL server (200) is authorized to initiate the monitoring events subscription request, and if the VAL server (200) is authorized, then the NRM (150) of the SEAL server (100) sends the monitoring events subscription response message, indicating the successful subscription status along with subscription information to the VAL server (200).

At S303, based on the events of interest information in the monitoring events subscription request, the NRM (150) of the SEAL server (100) subscribes to the UE monitoring events (e.g. loss of connectivity, communication failure, etc.) for the set of UEs (i.e. the VAL-UE (400)) in the monitoring events subscription request, as specified in 3GPP TS 23.502.

At S304, based on the events of interest information in the monitoring events subscription request, the NRM (150) of the SEAL server (100) subscribes to the UE analytics events (e.g. abnormal behaviour, etc.) for the set of UEs (i.e. the VAL-UE (400)) in the monitoring events subscription request, as specified in 3GPP TS 23.288.

Referring to FIG. 4: At S401, the NRM (150) of the SEAL server (100) receives the VAL-UE (400) related monitoring event notifications from the 3GPP core network (i.e. 5GC (300)) as specified in 3GPP TS 23.502. At S402, the NRM (150) of the SEAL server (100) receives the VAL-UE (400) related analytics event notifications from the 3GPP core network as specified in 3GPP TS 23.288. At S403, the NRM (150) of the SEAL server (100) notifies the VAL server (200) about the events related to the VAL-UE (400) in the notify monitoring events message. If multiple events are to be notified, then the NRM (150) of the SEAL server (100) may aggregate the notifications and send them to the VAL server (200).

In an embodiment, a UAE client on an authorized UAV, requests the UAE server for detection of problematic UAVs. In such a scenario, the UAE client sends the “Detect Problematic UAV (i.e. Monitor Event Subscription Request in S301) Request” with applicable parameters to the UAE server and the UAE server as the VAL server (200), uses the procedures in FIG. 3 and FIG. 4 to fetch problematic events of the UAV(s), notifies the UAE client of problematic event details of UAV(s) in “Notify Problematic UAV (i.e. Notify Monitoring Events message in S403)” message. The USS/UTM or SEAL or UAE server may authorize an UAV that is allowed to request for monitoring problematic events of UAVs.

In an embodiment, this solution can be used in combination (UAE supported detection of UAV's flight path deviation) to detect additionally the problematic events of the UAVs that are deviating from the area of interest. In such a scenario, the parameters (area of interest information, deviation threshold) of “Monitor Location Subscription Request as in S201” message shall be included in “Detect Problematic UAV Request (i.e. Monitor Event Subscription Request in S301)” message for each UAV ID that the USS/UTM requests to monitor. UAE server upon receiving the area of interest information from USS/UTM, shall monitor and detect the problematic UAV's that deviate from the area of interest location as illustrated in FIG. 2 and report the detections in “Notify Problematic UAV (i.e. Notify Monitoring Events message in S403)” message.

In another embodiment, the SEAL server (for e.g. Network Resource Manager or any other SEAL server) may be enhanced to support the Problematic UAV (i.e. Monitoring Events service as in FIG. 3) service as illustrated above for UAE server. In such case, the USS/UTM may directly consume the service from SEAL or the UAE server may consume this service from the SEAL server on behalf of USS/UTM. SEAL being an enabler layer for multiple verticals, such enhancement at SEAL will enable multiple verticals to leverage SEAL to detect the vertical specific problematic UEs.

In an embodiment, an UAE client on an authorized UAV, requests the UAE server for tracking of location information of another UAV. In such scenario, the UAE client sends the “Track UAV Fight Path request (i.e. Monitor Location Subscription Request as in S201)” message with applicable parameters and the UAE server notifies the UAE client about the other UAV's location deviation details in “Notify Mismatch Location” and “Notify Flight Path (i.e. Notify absence as in S208)” messages. The USS/UTM or SEAL or UAE server may authorize an UAV that is allowed to request for tracking of UAV location information.

In an embodiment, the “Track UAV Fight Path Request (i.e. Monitor Location Subscription Request as in S201) message may not include the location information details like Flight Path, deviation threshold. In such a scenario, the UAE server is aware of the UAV's pre-scheduled location information.

In another solution alternative, the SEAL server may expose the Track UAV Flight Path (i.e. Monitoring Location Information service as per FIG. 2) service offering the service described above as new SEAL service. In such a case, UAS server or USS/UTM directly consumes the Track UAV Flight Path service (i.e. Monitoring Location Information service as per FIG. 2) from SEAL. SEAL LMS fetches the UAV's current location from the location management client of the UAV. Adding such functionality in SEAL, will also allow other verticals like V2XAPP, to track the respective vertical specific UE path.

In an another embodiment, the UAV control function (UCF) as defined in TR 23.754, gathers the UAV location information and augments it with additional positioning or location information and shares with UAE server. UAE server determines flight path deviation based on augmented information from UCF. In such a scenario, the UAE server additionally subscribes to UAV's location information from the UCF and uses that information in determining the detection of UAV's flight path deviation.

FIG. 5 illustrates a user equipment (UE) according to embodiments of the present disclosure.

Referring to the FIG. 5, the UE 500 may include a processor 510, a transceiver 520 and a memory 530. However, all of the illustrated components are not essential. The UE 500 may be implemented by more or less components than those illustrated in FIG. 5. In addition, the processor 510 and the transceiver 520 and the memory 530 may be implemented as a single chip according to another embodiment.

The aforementioned components will now be described in detail.

The processor 510 may include one or more processors or other processing devices that control the proposed function, process, and/or method. Operation of the UE 500 may be implemented by the processor 510.

The transceiver 520 may include a RF transmitter for up-converting and amplifying a transmitted signal, and a RF receiver for down-converting a frequency of a received signal. However, according to another embodiment, the transceiver 520 may be implemented by more or less components than those illustrated in components.

The transceiver 520 may be connected to the processor 510 and transmit and/or receive a signal. The signal may include control information and data. In addition, the transceiver 520 may receive the signal through a wireless channel and output the signal to the processor 510. The transceiver 520 may transmit a signal output from the processor 510 through the wireless channel.

The memory 530 may store the control information or the data included in a signal obtained by the UE 500. The memory 530 may be connected to the processor 510 and store at least one instruction or a protocol or a parameter for the proposed function, process, and/or method. The memory 530 may include read-only memory (ROM) and/or random access memory (RAM) and/or hard disk and/or CD-ROM and/or DVD and/or other storage devices.

FIG. 5 illustrates a VAL-user equipment (UE) according to embodiments of the present disclosure.

Referring to the FIG. 5, the VAL-UE 500 may include a processor 510, a transceiver 520 and a memory 530. However, all of the illustrated components are not essential. The VAL-UE 500 may be implemented by more or less components than those illustrated in FIG. 5. In addition, the processor 510 and the transceiver 520 and the memory 530 may be implemented as a single chip according to another embodiment.

The aforementioned components will now be described in detail.

The processor 510 may include one or more processors or other processing devices that control the proposed function, process, and/or method. Operation of the VAL-UE 500 may be implemented by the processor 510.

The transceiver 520 may include a RF transmitter for up-converting and amplifying a transmitted signal, and a RF receiver for down-converting a frequency of a received signal. However, according to another embodiment, the transceiver 520 may be implemented by more or less components than those illustrated in components.

The transceiver 520 may be connected to the processor 510 and transmit and/or receive a signal. The signal may include control information and data. In addition, the transceiver 520 may receive the signal through a wireless channel and output the signal to the processor 510. The transceiver 520 may transmit a signal output from the processor 510 through the wireless channel.

The memory 530 may store the control information or the data included in a signal obtained by the VAL-UE 500. The memory 530 may be connected to the processor 510 and store at least one instruction or a protocol or a parameter for the proposed function, process, and/or method. The memory 530 may include read-only memory (ROM) and/or random access memory (RAM) and/or hard disk and/or CD-ROM and/or DVD and/or other storage devices.

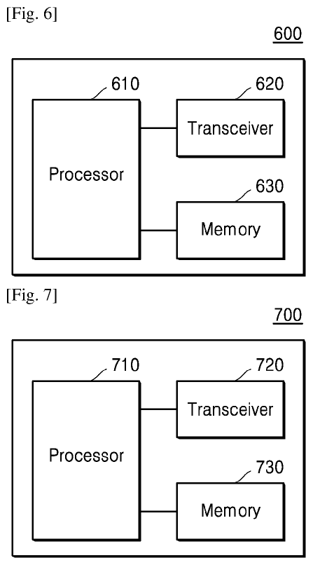

FIG. 6 illustrates an entity according to embodiments of the present disclosure.

Referring to the FIG. 6, the entity 600 may include a processor 610, a transceiver 620 and a memory 630. However, all of the illustrated components are not essential. The entity 600 may be implemented by more or less components than those illustrated in FIG. 6. In addition, the processor 610 and the transceiver 620 and the memory 630 may be implemented as a single chip according to another embodiment.

The 5GC 300 may include the entity 600. For example, the entity 600 may correspond to at least one of Access and Mobility Management function (AMF), Session Management function (SMF), User plane function (UPF), Policy Control Function (PCF), Authentication Server Function (AUSF), Unified Data Management (UDM), Application Function (AF), Network Exposure function (NEF), NF Repository function (NRF), or Network Slice Selection Function (NSSF).

The aforementioned components will now be described in detail.

The processor 610 may include one or more processors or other processing devices that control the proposed function, process, and/or method. Operation of the entity 600 may be implemented by the processor 610.

The transceiver 620 may include a RF transmitter for up-converting and amplifying a transmitted signal, and a RF receiver for down-converting a frequency of a received signal. However, according to another embodiment, the transceiver 620 may be implemented by more or less components than those illustrated in components.

The transceiver 620 may be connected to the processor 610 and transmit and/or receive a signal. The signal may include control information and data. In addition, the transceiver 620 may receive the signal through a wireless channel and output the signal to the processor 610. The transceiver 620 may transmit a signal output from the processor 610 through the wireless channel.

The memory 630 may store the control information or the data included in a signal obtained by the entity 600. The memory 630 may be connected to the processor 610 and store at least one instruction or a protocol or a parameter for the proposed function, process, and/or method. The memory 630 may include read-only memory (ROM) and/or random access memory (RAM) and/or hard disk and/or CD-ROM and/or DVD and/or other storage devices.

FIG. 7 illustrates a server according to embodiments of the present disclosure.

Referring to the FIG. 7, the server 700 may include a processor 710, a transceiver 720 and a memory 730. However, all of the illustrated components are not essential. The server 700 may be implemented by more or less components than those illustrated in FIG. 7. In addition, the processor 710 and the transceiver 720 and the memory 730 may be implemented as a single chip according to another embodiment.

For example, the server 700 may correspond to at least one of SEAL server 100 or VAL server 200.

The aforementioned components will now be described in detail.

The processor 710 may include one or more processors or other processing devices that control the proposed function, process, and/or method. Operation of the server 700 may be implemented by the processor 710.

The transceiver 720 may include a RF transmitter for up-converting and amplifying a transmitted signal, and a RF receiver for down-converting a frequency of a received signal. However, according to another embodiment, the transceiver 720 may be implemented by more or less components than those illustrated in components.

The transceiver 720 may be connected to the processor 710 and transmit and/or receive a signal. The signal may include control information and data. In addition, the transceiver 720 may receive the signal through a wireless channel and output the signal to the processor 710. The transceiver 720 may transmit a signal output from the processor 710 through the wireless channel.

The memory 730 may store the control information or the data included in a signal obtained by the server 700. The memory 730 may be connected to the processor 710 and store at least one instruction or a protocol or a parameter for the proposed function, process, and/or method. The memory 730 may include read-only memory (ROM) and/or random access memory (RAM) and/or hard disk and/or CD-ROM and/or DVD and/or other storage devices.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a service enabler architecture layer (SEAL) server for monitoring location information of at least one vertical application layer (VAL)-user equipment (UE) in a wireless network, the method comprises:
receiving, by a location management service (LMS) of the SEAL server, a monitor location subscription request from a VAL server;
determining, by the LMS, the location information of the at least one VAL-UE; and
sending, by the LMS, a monitor location subscription response to the VAL server, wherein the monitor location subscription response indicates that the LMS accepts the monitor location subscription request to monitor the location information of the at least one VAL-UE.

2. The method of claim 1, wherein the location information comprises a deviation in the location information.

3. The method of claim 1, wherein the monitor location subscription request comprises at least one of an identifier of the at least one VAL-UE (VAL-UE-ID), an area of interest information of the at least one VAL-UE, a notify interval or a target notification of uniform resource identifier (URI).

4. The method of claim 1, wherein determining, by the LMS, the location information of the at least one VAL-UE comprises:
processing, by the LMS, the area of interest information received in the monitor location subscription request;
subscribing, by the LMS, to the location information of the at least one VAL-UE from a core network by mapping a plurality of parameters, wherein the plurality of parameters comprises a location type, a monitoring type, and an accuracy level; and
periodically receiving, by the LMS, the location information of the at least one VAL-UE from the core network based on the subscription.

5. The method of claim 1, wherein determining, by the LMS, the location information of the at least one VAL-UE comprises:
subscribing, by the LMS, to the location information of the at least one VAL-UE from a SEAL location information procedures; and
periodically receiving, by the LMS, the location information of the at least one VAL-UE from the SEAL location information procedures based on the subscription.

6. The method of claim 1, further comprising:
monitoring the location information of the at least one VAL-UE.

7. The method of claim 6, further comprising monitoring the location information of the at least one VAL-UE.

8. The method as claimed in claim 7, wherein monitoring the location information of the at least one VAL-UE comprises:
determining, by the LMS, whether the received location information of the at least one VAL-UE from the core network matches with the received location information of the at least one VAL-UE from the SEAL location information procedures; and
performing, by the LMS, one of:
sending a notify mismatch location message to the VAL server in response to determining that the received location information of the at least one VAL-UE from the core network does not match with the received location information of the at least one VAL-UE from the SEAL location information procedures; or
sending at least one of a notify presence message or a notify absence message to the VAL server in response to determining that the received location information of the at least one VAL-UE from the core network matches with the received location information of the at least one VAL-UE from the SEAL location information procedures.

9. The method of claim 8, wherein sending the at least one of a notify presence message and a notify absence message to the VAL server comprises:
determining, by the LMS, whether a current location of the at least one VAL-UE is within the area of interest; and
performing, by the LMS, one of:
sending the notify presence message to the VAL server in response to determining that the current location of the at least one VAL-UE is within the area of interest, or
sending the notify absence message to the VAL server in response to determining that the current location of the at least one VAL-UE is not within the area of interest.

10. The method of claim 8, wherein the notify mismatch location message, the notify presence message, and the notify absence message comprises the at least one VAL-UE-ID, the location information of the at least one VAL-UE from the core network, or the location information of the at least one VAL-UE from the SEAL location information procedures.

11. A Service Enabler Architecture Layer (SEAL) server for monitoring location information of at least one Vertical Application Layer (VAL) User Equipment (VAL-UE) in a wireless network, the SEAL server comprises:
a transceiver; and
at least one processor operably connected to the transceiver and configured to:
receive a monitor location subscription request from a VAL server;
determine the location information of the at least one VAL-UE; and
send a monitor location subscription response to the VAL server, wherein the monitor location subscription response indicates that a location management service (LMS) of the SEAL server accepts the monitor location subscription request to monitor the location information of the at least one VAL-UE.

12. The SEAL server of claim 11, wherein the location information comprises a deviation in the location information.

13. The SEAL server of claim 11, wherein the monitor location subscription request comprises at least one of an identifier of the at least one VAL-UE (VAL-UE-ID), an area of interest information of the at least one VAL-UE, a notify interval or a target notification of uniform resource identifier (URI).

14. The SEAL server of claim 11, wherein the at least one processor is configured to:
process the area of interest information received in the monitor location subscription request;
subscribe to the location information of the at least one VAL-UE from a core network by mapping a plurality of parameters, wherein the plurality of parameters comprises a location type, a monitoring type, and an accuracy level; and
periodically receive the location information of the at least one VAL-UE from the core network based on the subscription.

15. The SEAL server of claim 11, wherein the at least one processor is configured to:
determine the location information of the at least one VAL-UE comprises:
subscribe to the location information of the at least one VAL-UE from a SEAL location information procedures; and
periodically receive the location information of the at least one VAL-UE from the SEAL location information procedures based on the subscription.
